(19) United States
(12) Patent Application Publication
(10) Pub. No.: US 2011/0078567 A1
(43) Pub. Date: Mar. 31, 2011

(54) APPARATUS AND METHOD FOR PROVIDING VIRTUAL KEYBOARD

(75) Inventors: Byungsun KIM, Seoul (KR); Young Hee LEE, Seoul (KR)

(73) Assignee: PANTECH CO., LTD., Seoul (KR)

(21) Appl. No.: 12/779,573

(22) Filed: May 13, 2010

(30) Foreign Application Priority Data
Sep. 30, 2009 (KR) 10-2009-0093545

(51) Int. Cl. G06F 3/041; G06F 3/02; G06F 3/048

(52) U.S. Cl. 715/702; 345/168; 345/173; 715/773; 715/765

(57) ABSTRACT

An apparatus includes a key providing unit to arrange one key group in a main touch area and to arrange remaining key groups in sub-touch area, a touch screen to display a virtual keyboard and to receive an input, and an input recognizing unit to recognize a user-inputted direction gesture. The key providing unit decreases the size of the key group in the main touch area and moves it to the sub-touch area, enlarges a size of a key group corresponding to the direction of the direction gesture and moved into the main touch area. A method to display the virtual keyboard also includes decreasing the size of the key group in the main touch area and rearranging it into the sub-touch area, enlarging a size of a key group in the sub-touch area receiving a click input, and arranging it into the main touch area.

### CROSS-REFERENCE TO RELATED APPLICATION

This application claims priority from and the benefit of Korean Patent Application No. 10-2009-0093545, filed on Sep. 30, 2009, which is hereby incorporated by reference for all purposes as if fully set forth herein.

### BACKGROUND

1. Field of the Invention

The present invention relates to a user input apparatus and method, and more particularly, to an apparatus and a method for providing a virtual keyboard.

2. Discussion of the Background

A virtual keypad scheme using a touch screen is used for economizing a space for a keypad in a portable terminal. Particularly, in a portable terminal having a full touch screen, an input scheme using the touch screen may supplement or be a replacement for a physical keypad.

The virtual keypad scheme provides the virtual keypad via a touch screen. However, the virtual keypad has a format that imitates a conventional keypad but keys may be arranged too closely without accommodating the types of key entries made by a user. Thus, an error may occur when the wrong key is touched inadvertently by a user on the touch screen.

The virtual keypad scheme may not effectively use resources of the full touch screen that utilizes a wider input space compared with a partial touch screen or a keypad input scheme.

### SUMMARY

Exemplary embodiments of the present invention provide a virtual keyboard that may be rearranged according to a direction gesture or a touch input in a touch screen terminal.

Additional features of the invention will be set forth in the description which follows, and in part will be apparent from the description, or may be learned by practice of the invention.

An exemplary embodiment of the present invention discloses a virtual keyboard apparatus, the virtual keyboard apparatus including a touch screen having a main touch area and a sub-touch area, the touch screen to display a virtual keyboard having a plurality of key groups, a key providing unit to arrange a first key group in the main touch area, and to arrange a second key group in the sub-touch area, and an input recognizing unit to recognize a type of user input applied to the touch screen, and to calculate a direction of a direction gesture if the user input is the direction gesture. Here, if the user input is the direction gesture and the direction corresponds to the second key group, the key providing unit decreases a size of the first key group arranged in the main touch area, arranges the first key group in the sub-touch area, enlarges a size of the second key group arranged in the sub-touch area, and arranges the second key group in the main touch area.

An exemplary embodiment of the present invention also discloses a method for providing a virtual keyboard. The method includes arranging a first key group in a main touch area, decreasing a size of a second key group, and arranging the second key group in a sub-touch area, receiving a user input, calculating a direction of a direction gesture if the user input is the direction gesture, and if the direction corresponds to the second key group, decreasing a size of the first key group arranged in the main touch area, arranging the first key group in the sub-touch area, enlarging a size of the second key group arranged in the sub-touch area, and arranging the second key group in the main touch area.

An exemplary embodiment of the present invention further discloses a virtual keyboard apparatus, the virtual keyboard apparatus including a key providing unit to arrange a first key group in a main touch area, to decrease a size of a second key group, and to arrange the second key group in a sub-touch area, a touch screen to display a virtual keyboard having the main touch area and the sub-touch area, and to sense a user input, and an input recognizing unit to calculate a direction of a direction gesture if the user input is the direction gesture. Here, if the user input is the direction gesture in a direction corresponding to the second key group, the key providing unit arranges the second key group in the main touch area.

An exemplary embodiment of the present invention still further discloses a method for providing a virtual keyboard. The method includes arranging a first one key group in a main touch area, decreasing a size of a plurality of key groups, and arranging the plurality of key groups in a sub-touch area, receiving a user input, calculating a direction of a direction gesture if user input is the direction gesture, and arranging a second key group corresponding to the direction of the direction gesture in the main touch area.

An exemplary embodiment of the present invention also discloses a virtual keyboard apparatus, the virtual keyboard apparatus including a key providing unit to arrange a first key group in a main touch area, to decrease a size of a second key group, and to arrange the second key group in a sub-touch area, and a touch screen to display a virtual keyboard having the main touch area and the sub-touch area, and to sense a user input. Here, if the user input is a click input on the second key group of the sub-touch area, the first key group arranged in the main touch area is decreased in size and arranged in the sub-touch area, and the second key group receiving the click input is enlarged and arranged in the main touch area.

An exemplary embodiment of the present invention also discloses a method for providing a virtual keyboard. The method includes arranging a first key group in a main touch area, decreasing a size of a plurality of key groups, and arranging the plurality of key groups in a sub-touch area, receiving a user input, determining a key group touched by a click input if the user input is the click input inputted to the sub-touch area, decreasing a size of the first key group arranged in the main touch area, arranging the first key group in the sub-touch area, enlarging a second key group receiving the click input, and arranging the second key group in the main touch area.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating a virtual keyboard apparatus according to an exemplary embodiment of the present invention.

FIG. 2 is a diagram illustrating a virtual keyboard according to an exemplary embodiment of the present invention.

FIG. 3 is a diagram illustrating a mobile screen displaying a virtual keyboard according to an exemplary embodiment of the present invention.

FIG. 4 is a diagram illustrating a mobile screen displaying a virtual keyboard according to an exemplary embodiment of the present invention.

FIG. 5 is a flowchart illustrating a method for providing a virtual keyboard according to an exemplary embodiment of the present invention.

FIG. 6 is a diagram illustrating a virtual keyboard according to an exemplary embodiment of the present invention.

FIG. 7 is a diagram illustrating a mobile screen displaying a virtual keyboard according to an exemplary embodiment of the present invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

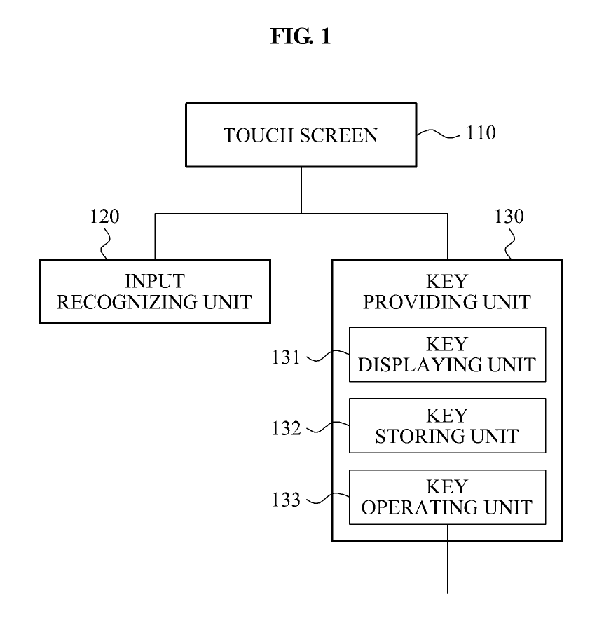

FIG. 1 illustrates a virtual keyboard apparatus according to an exemplary embodiment of the present invention.

The virtual keyboard apparatus may include a touch screen 110, an input recognizing unit 120, and a key providing unit 130.

The touch screen 110 may be a liquid crystal display (LCD) or another display technology, such as organic light emitting diode (OLED) display, combined with technology for receiving a touch input. The touch screen 110 may include an LCD controlling unit, a memory that stores displayed data, an LCD display device, and the like, and may display a user interface (UI) or a graphic user interface (GUI). The touch screen 110 may sense a touch input, applied as a user input. As an example, the touch screen 110 may sense the touch input by detecting a change of a physical quantity, such as a pressure and/or a capacitance, or may receive the user input by using the change of the physical quantity, when the touch input occurs.

The touch input may include at least one of a touch, which also may be referred to herein as a click input, and a direction gesture, which will be referred to herein as a drag input.

The input recognizing unit 120 may determine whether the received touch input is the click input or the drag input, may generate a signal based on the determination, and may transmit the generated signal to a key providing unit 130.

If the touch input is a click input, the input recognizing unit 120 determines that the touch input is the click input and generates a signal, which will be referred to as a touch input signal. Then, the input recognizing unit 120 may transmit the touch input signal to the key providing unit 130. In this instance, the touch input signal may include information identifying coordinates where the touch input of the user occurs.

If the user input is a direction gesture, the input recognizing unit 120 may calculate an angle or direction corresponding to the direction gesture. The direction gesture is a user input having a dragged direction, like a drag input, while contacting the touch screen 110. The exemplary embodiments will be described by referring to the drag input as an example of a direction gesture.

If the touch input is a drag input, the input recognizing unit 120 may calculate an angle of a vector based on a first point, such as a start point, and a second point, such as an end point, of the drag input. The input recognizing unit 120 transmits the signal including the calculated angle to the key providing unit 130. In this instance, the input recognizing unit 120 may calculate the angle of the vector that connects the first point and the second point, at a time when a drag input is finished, the angle being referred to as a drag angle.

When a size of the vector based on the drag input is greater than or equal to a predetermined size, the input recognizing unit 120 may calculate an angle or direction of a corresponding drag input before the drag input of the user is finished, namely before the touch screen recognizes a release of the drag input, and may transmit the calculated angle to the key providing unit 130.

The key providing unit 130 may provide an image of the virtual keyboard on the touch screen 110, may generate a signal based on a manipulation of the arranged key, and may output the generated signal to an external apparatus, the signal being referred to as a key manipulation signal. The key providing unit 130 may include a key displaying unit 131, a key storing unit 132, and key operating unit 133.

The key displaying unit 131 may generate an image of the virtual keyboard that is arranged according to the drag input or click input of the user. In this instance, the key displaying unit 131 may classify an area where the virtual keyboard is displayed into a main touch area and a sub-touch area. The main touch area is an area that receives the touch input of the user. The sub-touch area is an area that displays decreased sizes of keys included in key groups, excluding the key group displayed on a main touch area.

The key storing unit 132 may store key area information, a key group, and a range of a drag angle corresponding to each key group or to each sub-touch area. The key area information is information, such as coordinates, indicating an area of each key to be displayed on the main touch area or on the sub-touch area.

When a key group is displayed on the main touch area, the key storing unit 132 stores corresponding key area information of the key group. As an example, the key storing unit 132 may store a key area of each arranged key when a key group including a number key is displayed on the main touch area. Similarly, when the number key group is displayed on the sub-touch area, the key storing unit 132 stores a key area of each arranged key in this arrangement. The key storing unit 132 separately stores a key area of each arranged key when a key group including a function key is displayed on the main touch area. That is, the key storing unit 132 may store a plurality of key areas according to which key group is arranged on the main touch area and which key groups are displayed on the sub-touch area.

Hereinafter, it is assumed that a positive direction of a y-axis on a plane of the touch screen 110 is set to zero degrees and a drag angle increases in a clockwise direction.

The key storing unit 132 may store the key group including the number key, and may store a drag angle corresponding to the key group including the number key. This corresponding drag angle may be greater than or equal to 30 degrees and less than 90 degrees. When a received drag input has a drag angle that is 45 degrees, the key displaying unit 131 may verify a range of a drag angle stored in the key storing unit 132, and may generate an image of the virtual keyboard so as to display a number key group on the main touch area. A key group that was previously displayed on the main touch area is therefore moved to the sub-touch area.

That is, the key displaying unit 131 may extract, from the key storing unit 132, key area information corresponding to the drag angle among key area information, may generate an image of the virtual keyboard according to the extracted key area information, and may transmit the generated image to the touch screen 110.

The key operating unit 133 may extract, from the key storing unit 132, key area information corresponding to the drag angle among the key area information. When a touch input signal corresponding to a click input received from the input recognizing unit 120 includes coordinates corresponding to the main touch area, the key operating unit 133 may determine that a key corresponding to the corresponding coordinates is pushed, and may generate a corresponding code, as an example, an ASCII code, and output the generated code to the external apparatus. Thus, the key operating unit 133 recognizes that a user is inputting a click input corresponding to typing a key corresponding to the coordinates on the main touch area. Here, the “external apparatus” may be an apparatus that is external to the key providing unit 130, and may include, for example, a microprocessor of a mobile terminal including the touch screen 110 and the key providing unit 130. Alternatively, the external apparatus may be an apparatus, such as a computer or remotely located wireless terminal, that is external to the apparatus including the key providing unit 130.

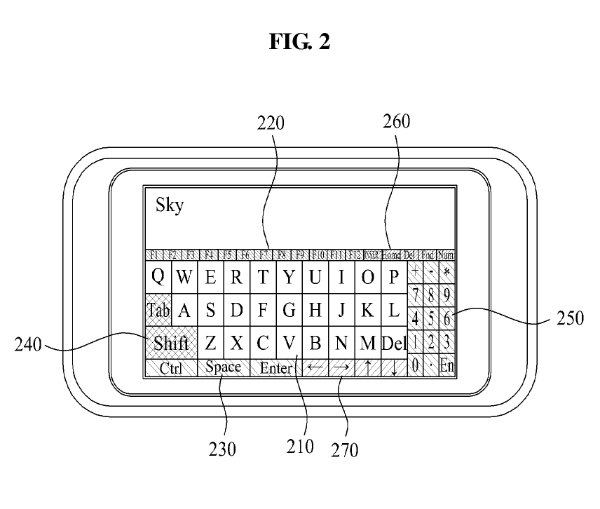

Hereinafter, a process of rearranging the appearance of a virtual keyboard according to an exemplary embodiment of the present invention will be further described with reference to FIG. 2.

FIG. 2 illustrates a virtual keyboard according to an exemplary embodiment of the present invention.

Referring to FIG. 2, a virtual keyboard may include a character key group 210, a function key group 220, a first special key group 230, a second special key group 240, a number key group 250, a cursor key group 260, and a direction key group 270. In this instance, the virtual keyboard of FIG. 2 is a virtual keyboard displayed in an arrangement that the key displaying unit 131 may determine as a default display arrangement.

The key operating unit 133 may arrange the character key group 210 in the main touch area according to virtual keyboard location information received from the key displaying unit 131, and may arrange remaining key groups in the sub-touch area to be similar to a format of a general QWERTY keyboard. In this instance, the key storing unit 132 may decrease a size of key groups arranged in the sub-touch area and stores arranged key area information. In this instance, the key storing unit 132 may store key area information of a key group that is arranged in the sub-touch area and is decreased in display size. The key displaying unit 131 may generate an image of a virtual keyboard in which each key group has a different color to be distinguished from an adjacent key group. The key operating unit 133 may generate an image of a virtual keyboard in which each key group has an outline to be distinguished from each other.

When the key displaying unit 131 receives a drag angle from the input recognizing unit 120, the key displaying unit 131 may determine a key group corresponding to the drag angle from the key storing unit 132. The key displaying unit 131 may generate an image of a virtual keyboard in which the key group corresponding to the drag angle is enlarged and is displayed in the main touch area and remaining key groups are decreased in size and are displayed in the sub-touch area.

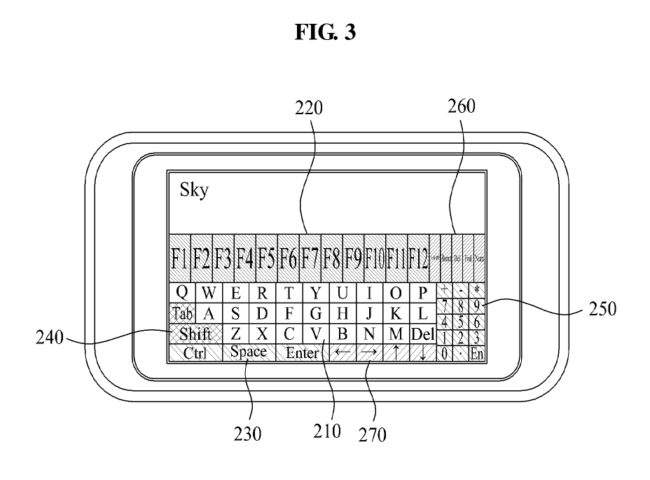

Hereinafter, a virtual key board rearranged according to an exemplary embodiment of the present invention will be described with reference to FIG. 3. In this instance, the key displaying unit 131 receives a user input indicating that the function key group 220 is to be located in the main touch area.

FIG. 3 is illustrates a mobile screen displaying a virtual keyboard according to an exemplary embodiment of the present invention.

Referring to FIG. 3, the key storing unit 132 stores key area information corresponding to the function key group 220 being enlarged and displayed on a main touch area. In this instance, the character key group 210 on the main touch area is decreased in size and is displayed in a lower end of a sub-touch area. The key storing unit 132 may store key area information corresponding to the character key group 210 located above the first special key group 230, and the direction key group 270 located to the right of the first special key group 230 and in the lower end of the sub-touch area. That is, the key storing unit 132 may maintain a relative location between the key groups while storing key area information indicating where the key groups are displayed in the main touch area and in the sub-touch area. The key displaying unit 131 may generate a virtual key board image according to the key area information and may display the virtual keyboard image on the touch screen 110.

A height of the second special key group 240 located in a side of the character group 210 and a height of the number key group 250 located in another side of the character group 210 are decreased by a distance corresponding to a distance by which the height of the function key group 220 increases. A height of the cursor key group 260 is enlarged to be identical to a height of the function key group 220, and a width of the cursor key group 260 is decreased by a distance corresponding to a distance by which the width of the function key group 220 increases, and is displayed on a right side of the sub-touch area.

That is, the key displaying unit 131 may display a virtual keyboard image in which a height of an area located to a side of a key group displayed in the main touch area is enlarged to be identical to a height of the key group displayed on the main touch area. Similarly, a width of the key group area of the sub-touch area is decreased to a predetermined magnitude. The key displaying unit 131 may display a virtual keyboard image in which a width of an area located above or below the key group displayed in the main touch area is enlarged to be identical to a width of the key group displayed on the main touch area. Similarly, a height of the key group displayed on the sub-touch area is decreased to a predetermined magnitude.

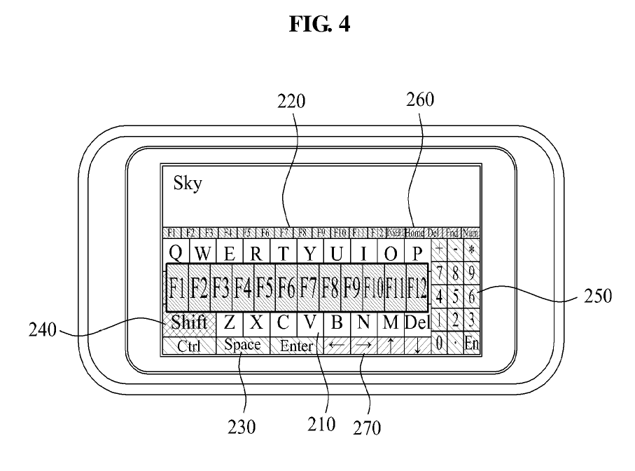

FIG. 4 illustrates a mobile screen displaying a virtual keyboard according to an exemplary embodiment of the present invention.

Referring to FIG. 4, the key storing unit 132 may store key area information of a key located in a sub-touch area regardless of a drag angle, and may separately store key area information corresponding to the drag angle, only with respect to a key to be arranged in a main touch area. That is, the key storing unit 132 may separately store only key area information to be used when a corresponding key group is displayed on the main touch area, among key area information corresponding to a function key group 220, the first special key group 230, the second special key group 240, the number key group 250, the cursor key group 260, and the direction key group 270. The separately stored key area information is referred to as main key area information.

The key displaying unit 131 may extract, from the key storing unit 132, main key area information of a key arranged in the main touch area according to a drag angle, a default arrangement, or a click input, and may display the main touch area of the virtual keyboard based on the main key area information. As an example, the key operating unit 133 may display keys of function key group 220 on the main touch area according to main key area information corresponding to the function key group 220, when a key group corresponding to the drag angle is the function key group 220. In this instance, the key operating unit 133 may not change a location or a size of a key located in the sub-touch area.

Although the process of rearranging the virtual keyboard describes that the virtual keyboard is rearranged according to the drag angle, the key providing unit 130 may rearrange the virtual keyboard to display a corresponding key group in the main touch area according to a click input of a key group displayed on the sub-touch area. As an example, if the key providing unit 130 receives a click input to a key group displayed on the sub-touch area of the virtual keyboard displayed on the touch screen 110, the key providing unit 130 displays a corresponding key group receiving the click inpt on the main touch area and may display remaining key groups on the sub-touch area.

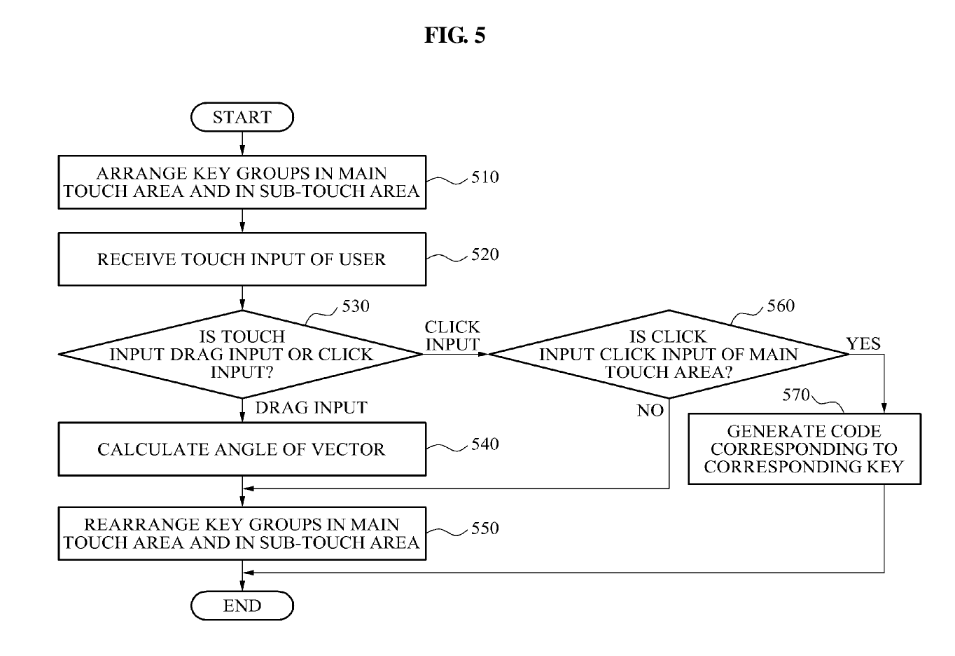

FIG. 5 is a flowchart illustrating a method for providing a virtual keyboard according to an exemplary embodiment of the present invention. FIG. 5 will be described with reference to the virtual keyboard apparatus shown in FIG. 1 for convenience, without being specifically limited thereto.

Referring to FIG. 5, the virtual keyboard apparatus may arrange key groups in a main touch area and a sub-touch area in operation 510. The virtual keyboard apparatus may store a location and a size of a key included in each key group in advance or according to a default arrangement.

The virtual keyboard apparatus may receive a touch input of a user in operation 520. That is, the virtual keyboard apparatus may receive the touch input of the user through the touch screen 110.

The virtual keyboard apparatus may determine whether the touch input of operation 520 is a drag input in operation 530.

If the touch input is determined as the drag input in operation 530, the virtual keyboard apparatus may calculate an angle of a vector of the drag input in operation 540.

The virtual keyboard apparatus may rearrange key groups in the main touch area and the sub-touch area in operation 550. In this instance, the virtual keyboard apparatus may store a location and a size of a key group corresponding to the touch input and the drag input of the user in advance. A more detailed location and size of the key group have been described with reference to FIG. 3 and FIG. 4.

When the touch input is determined as a click input in operation 530, the virtual keyboard apparatus may determine whether the corresponding click input is a click input on the main touch area in operation 560.

When the touch input is the click input on the main touch area, the virtual keyboard apparatus may generate a code corresponding to a key pushed by the corresponding touch input in operation 570.

If the touch input is a click input on the sub-touch area, the virtual keyboard apparatus may rearrange the key groups in the main touch area and the sub-touch area in operation 550. As an example, if the virtual keyboard apparatus receives the click input on the sub-touch area, the virtual keyboard apparatus may decrease a key group on the main touch area, may arrange the decreased key group from the main touch area into the sub-touch area, may enlarge the clicked key group of the sub-touch area, and may arrange the enlarged key group from the sub-touch area into the main touch area.

The virtual keyboard apparatus may perform the described method at any time while providing the virtual keyboard according to the user inputs, or may include a timer function whereby the virtual keyboard returns to a default arrangement after a predetermined period of receiving no user inputs.

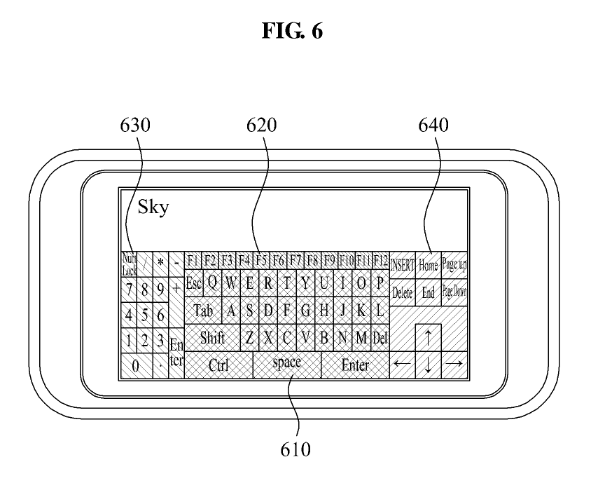

FIG. 6 illustrates a virtual keyboard according to an exemplary embodiment of the present invention.

Referring to FIG. 6, the virtual keyboard may include a character key group 610, a function key group 620, a number key group 630, and a cursor key group 640.

The virtual keyboard apparatus may arrange the character key group 610 in a main touch area, may decrease a size of the function key group 620, the number key group 630, and the cursor key group 610, and may arrange each of the decreased size key groups in a sub-touch area of a side of the main touch area.

In this instance, a process of rearranging each key group according to a user input is similar to a process described with reference to FIG. 2, FIG. 3, and FIG. 4, and thus, further descriptions thereof will be omitted.

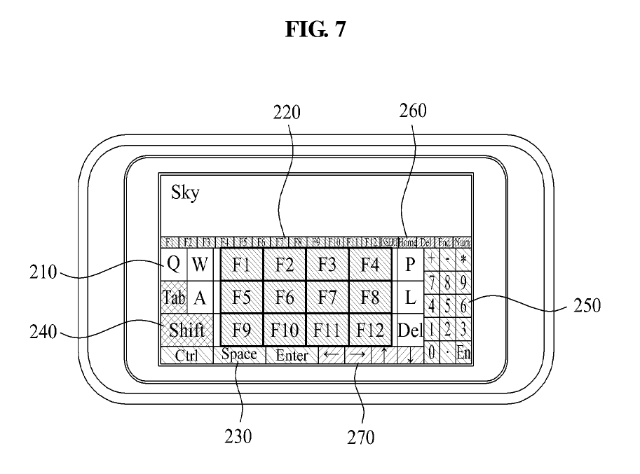

FIG. 7 illustrates a mobile screen displaying a virtual keyboard according to an exemplary embodiment of the present invention.

It is described herein, with reference to FIG. 2, FIG. 3, FIG. 4, FIG. 5, and FIG. 6, that the virtual keyboard is arranged to maintain a relative location between keys included in a key group displayed on the sub-touch area when moved to the main touch area and vice-versa.

However, a relative location between corresponding keys may be changed when the virtual keyboard is arranged in the main touch area. For example, as illustrated in FIG. 7, the function key group 220 may be arranged in the main touch area in a different arrangement including three rows of larger-sized keys, as compared to a single row when the function key group 220 is arranged in the sub-touch area. Further, the function key group 220 in the main touch area may overlap the character key group 210, also still displayed in the main touch-area.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A virtual keyboard apparatus, comprising:
a touch screen comprising a main touch area and a sub-touch area, the touch screen to display a virtual keyboard comprising a plurality of key groups;
a key providing unit to arrange a first key group in the main touch area, and to arrange a second key group in the sub-touch area; and
an input recognizing unit to recognize a type of user input applied to the touch screen, and to calculate a direction of a direction gesture if the user input is the direction gesture,
wherein if the user input is the direction gesture and the direction corresponds to the second key group, the key providing unit decreases a size of the first key group arranged in the main touch area, arranges the first key group in the sub-touch area, enlarges a size of the second key group arranged in the sub-touch area, and arranges the second key group in the main touch area.

2. The virtual keyboard apparatus of claim 1, wherein the key providing unit maintains a relative location between keys of the first key group while decreasing the size of the first key group and arranging the first key group in the sub-touch area.

3. The virtual keyboard apparatus of claim 1, wherein the key providing unit comprises:
a key storing unit to store key area information comprising a direction range corresponding to the first key group and the second key group, and coordinates information of keys of the first key group and the second key group;
a key displaying unit to generate an image of the virtual keyboard to be displayed on the touch screen according to the key area information and the direction of the direction gesture if the user input is the direction gesture; and
a key operating unit to generate a code corresponding to a touched key of the virtual keyboard if the user input is a click input on the main touch area.

4. A method for providing a virtual keyboard, comprising:
arranging a first key group in a main touch area, decreasing a size of a second key group, and arranging the second key group in a sub-touch area;
receiving a user input;
calculating a direction of a direction gesture if the user input is the direction gesture; and
if the direction corresponds to the second key group, decreasing a size of the first key group arranged in the main touch area, arranging the first key group in the sub-touch area, enlarging a size of the second key group arranged in the sub-touch area, and arranging the second key group in the main touch area.

5. The method of claim 4, further comprising maintaining a relative location between keys of the first key group while decreasing the size of the first key group and arranging the first key group in the sub-touch area.

6. The method of claim 4, further comprising:
generating a code corresponding to a touched key of the virtual keyboard if the user input is a click input on the touched key of the first key group arranged on the main touch area.

7. The method of claim 4, further comprising:
if the user input is a click input to the second key group arranged in the sub-touch area, decreasing the size of the first key group arranged in the main touch area, arranging the first key group in the sub-touch area, enlarging the size of the second key group arranged in the sub-touch area, and arranging the second key group in the main touch area.

8. A virtual keyboard apparatus, comprising:
a key providing unit to arrange a first key group in a main touch area, to decrease a size of a second key group, and to arrange the second key group in a sub-touch area;
a touch screen to display a virtual keyboard comprising the main touch area and the sub-touch area, and to sense a user input; and
an input recognizing unit to calculate a direction of a direction gesture if the user input is the direction gesture,
wherein if the user input is the direction gesture in a direction corresponding to the second key group, the key providing unit arranges the second key group in the main touch area.

9. The virtual keyboard apparatus of claim 8, wherein if the user input is the direction gesture in a direction corresponding to a third key group, the key providing unit arranges the third key group in the main touch area.

10. The virtual keyboard apparatus of claim 8, wherein the key providing unit comprises:
a key storing unit to store key area information comprising a direction range corresponding to the first key group and the second key group, and coordinates information of keys of the first key group and the second key group;
a key displaying unit to display an image of a virtual keyboard to be displayed on the touch screen according to the key area information and the direction of the direction gesture if the user input is the direction gesture; and
a key operating unit to generate a code corresponding to a touched key of the virtual keyboard if the user input is a click input on the main touch area.

11. A method for providing a virtual keyboard, comprising:
arranging a first one key group in a main touch area, decreasing a size of a plurality of key groups, and arranging the plurality of key groups in a sub-touch area;
receiving a user input;
calculating a direction of a direction gesture if user input is the direction gesture; and
arranging a second key group corresponding to the direction of the direction gesture in the main touch area.

12. The method of claim 11, further comprising enlarging a size of the second key group arranged in the sub-touch area, and arranging the second key group in the main touch area.

13. The method of claim 11, further comprising:
generating a code corresponding to a touched key of the virtual keyboard if the user input is a click input on the main touch area.

14. A virtual keyboard apparatus, comprising:
a key providing unit to arrange a first key group in a main touch area, to decrease a size of a second key group, and to arrange the second key group in a sub-touch area; and
a touch screen to display a virtual keyboard comprising the main touch area and the sub-touch area, and to sense a user input,
wherein if the user input is a click input on the second key group of the sub-touch area, the first key group arranged in the main touch area is decreased in size and arranged in the sub-touch area, and the second key group receiving the click input is enlarged and arranged in the main touch area.

15. The virtual keyboard apparatus of claim 14, wherein the key providing unit maintains a relative location between keys of the first key group while decreasing the size of the first key group and arranging the first key group in the sub-touch area.

16. The virtual keyboard apparatus of claim 14, wherein the key providing unit comprises:
a key storing unit to store key area information comprising coordinates information of keys of the first key group and the second key group;
a key displaying unit to display an image of a virtual keyboard to be displayed on the touch screen according to the key area information and the click input; and
a key operating unit to generate a code corresponding to a touched key of the virtual keyboard if the user input is the click input on the main touch area.

17. A method for providing a virtual keyboard, comprising:
arranging a first key group in a main touch area, decreasing a size of a plurality of key groups, and arranging the plurality of key groups in a sub-touch area;
receiving a user input;
determining a key group touched by a click input if the user input is the click input inputted to the sub-touch area; and
decreasing a size of the first key group arranged in the main touch area, arranging the first key group in the sub-touch area, enlarging a second key group receiving the click input, and arranging the second key group in the main touch area.

18. The method of claim 17, further comprising maintaining a relative location between keys of the first key group while the first key group in the main touch area is decreased in size and arranged in the sub-touch area.

19. The method of claim 17, further comprising:
generating a code corresponding to a touched key of the virtual keyboard if the user input is the click input on the main touch area.
